(19) United States
(12) Patent Application Publication
(10) Pub. No.: US 2005/0025291 A1
(43) Pub. Date: Feb. 3, 2005

(54) Method and system for information distribution management

(75) Inventors: Ariel Peled, Even-Yehuda (IL); Arik Baratz, Hadera (IL)

Correspondence Address: Martin MOYNIHAN;c/o ANTHONY CASTORINA, SUITE 207, 2001 JEFFERSON DAVIS HIGHWAY, ARLINGTON, VA, 22202, US

(73) Assignee: Vidius Inc.

(21) Appl. No.: 10/927,044

(22) Filed: Aug. 27, 2004

Related U.S. Application Data
(63) Continuation-in-part of application No. 10/003,269, filed on Dec. 6, 2001.
(63) Continuation-in-part of application No. 10/357,201, filed on Feb. 4, 2003.
(60) Provisional application No. 60/274,657, filed on Mar. 12, 2001.
(60) Provisional application No. 60/353,997, filed on Feb. 5, 2002.

(51) Int. Cl. H04M 1/64; H04M 11/00

(52) U.S. Cl. 379/88.13; 379/88.12; 379/88.22

(57) ABSTRACT

A method or apparatus for efficient handling of a blocked message in a digital traffic filtering system, the method comprising: sending a notification to an authorized person about the blocking of the message, and including therein an override feature by which the authorized person can override the blocking.

### CROSS-REFERENCE TO RELATED APPLICATIONS

This application is a continuation-in-part of pending U.S. patent application Ser. No. 10/003,269, filed Dec. 6, 2001, which claims priority from U.S. Provisional Patent Application No. 60/274,657, filed Mar. 12, 2001, now expired. This application is also a continuation-in-part of pending U.S. patent application Ser. No. 10/357,201, filed Feb. 4, 2003, which claims priority from U.S. Provisional Patent Application No. 60/353,997, filed Feb. 5, 2002, now expired. The contents of these above references are hereby incorporated herein in their entirety.

### FIELD OF THE INVENTION

The present invention relates generally to the field of information management. More specifically but not exclusively, the present invention deals with methods for an efficient handling of false positive indications of unauthorized dissemination of information in a digital traffic filtering system.

### BACKGROUND OF THE INVENTION

The information and knowledge created and accumulated by organizations and businesses are their most valuable assets. As such, managing and keeping the information and the knowledge inside the organization and restricting its distribution outside is of paramount importance for almost any organization, government entity or business, and provides a significant leverage of its value. Most of the information in modern organizations and businesses is represented in a digital format. Digital content can be easily copied and distributed (e.g., via e-mail, instant messaging, peer-to-peer networks, FTP and web-sites), which greatly increase hazards such as business espionage and data leakage. In addition, the distribution of digital items requires resources, such as costly bandwidth and precious employees time.

Another aspect of the problem is compliance with regulations with respect to information: Regulations within the United States of America, such as the Health Insurance Portability and Accountability Act (HIPPA), the Gramm-Leach-Bliley act (GLBA) and the Sarbanes Oxley act (SOXA) mean that the information assets within organizations need to be monitored and subjected to an information management policy, in order to protect clients privacy and to mitigate the risks of potential misuse and fraud.

Unauthorized dissemination of information therefore poses a severe risk from both business and legal perspectives. However, events of unauthorized dissemination of information, especially via e-mail, are prevalent and happen in large organizations almost on a daily basis.

Prior art solutions attempt several approaches for protecting confidential information, such as:
Filtering the digital traffic using keyword filtering (e.g., not allowing distribution of documents with the word “confidential” in them). These methods tend to be either over-exclusive or over-inclusive, and therefore causing a high rate of “false-positives” (false-alarms) and “false-negatives” (miss-detections).
Considering the binary signature of the file, which critically depends on the precise representation of the data.
Utilizing specialized digital rights management software, or rights management services, which allow handling of a confidential file only within a specialized protected environment. Such solutions tend to be cumbersome, and are, in general, not compatible with the regular organizational workflow. This drawback greatly limits the current distribution of the digital rights management solution.

A more effective approach is content-based monitoring and filtering of information traffic: this type of filtering, described in U.S. patent application, Publication No. 2002/0129140, filed Dec. 6, 2001, the contents of which are hereby incorporated herein by reference in their entirety, provides a tool for information traffic filtering which analyzes the information content of the traffic, regardless of its envelope and format. However, filtering methods and techniques comprise an inherent problem of false alarms and miss-detections, respectively known as false positive and false negative errors. In order to make such methods effective, it is imperative to provide an efficient method for handling these “false positive” and “false negative” errors, which would not hamper the workflow and would not consume resources.

There is thus a recognized need for, and it would be highly advantageous to have, a method and system that allow for efficient handling of false indications of unauthorized dissemination of information in a digital traffic filtering system which will overcome the drawbacks of current methods as described above.

### SUMMARY OF THE INVENTION

According to a first aspect of the present invention, a method for efficient handling of a blocked message in a digital traffic filtering system is described, the method comprising sending a notification to an authorized person about the blocking and including in the notification an override feature by which the authorized person can override the blocking.

In a preferred embodiment of the present invention the override feature within the notification comprises a digital code, and the method further comprising sending the code to a message releasing component responsible for releasing the blocked message, in order to allow releasing of the blocked message at the message releasing component.

In a preferred embodiment of the present invention the method comprising sending the digital code to the message releasing component using either one of a mail reply command and a mail forward command.

In a preferred embodiment of the present invention the digital code is used by the message-releasing component in order to identify the blocked message.

In a preferred embodiment of the present invention the digital code comprises a pseudo-random series of alphanumeric characters.

In a preferred embodiment of the present invention the method comprising transferring the code to predetermined users, thereby to enable the predetermined users to release the blocked email.

In a preferred embodiment of the present invention the digital code is sent to the authorized person in a manner in which it cannot be seen by the authorized person.

In a preferred embodiment of the present invention the authorized person comprises at least one of:
The sender of the mail;
The owner of an information item within the blocked mail;
The system administrator and,
The organization security officer.

In a preferred embodiment of the present invention the notification contains instructions with which the authorized person can release the blocked message.

In a preferred embodiment of the present invention the notification contains a copy of the blocked message.

In a preferred embodiment of the present invention an initiator of the blocked message receives a notification that does not contain the digital code.

In a preferred embodiment of the present invention the message is any of a group comprising: a client server communication, an email message, an email attachment, an SMS message, a instant messaging communication, a peer to peer communication, fax message and a file being transferred by a file transfer protocol.

In a preferred embodiment of the present invention the method further comprising authenticating the identity of the sender of the digital code.

In a preferred embodiment of the present invention the authenticating of the identity of the sender of the digital code is based on at least one of the following:
The sender email address inside the organization
The sender Media Access Control (MAC) address
Standard Public Key Infrastructure (PKI) authentication scheme

In a preferred embodiment of the present invention the message releasing component is a client program within a server.

According to a second aspect of the present invention, an apparatus for efficient handling of a blocked message in a digital traffic filtering system, the apparatus comprising:
a. A notification sending component for sending a notification to an authorized person about the blocking, the notification includes an override feature by which the authorized person can instruct to override the blocking
b. A message releasing component for releasing the blocked message upon receiving the override instructions from the authorized person.

In a preferred embodiment of the present invention the override feature within the notification comprises a digital code, and the code is sent to the message-releasing component.

In a preferred embodiment of the present invention the digital code is sent to the message releasing component using either one of a mail reply command and a mail forward command.

In a preferred embodiment of the present invention the digital code is used by the message-releasing component in order to identify the blocked message.

In a preferred embodiment of the present invention the digital code comprises a pseudo-random series of alphanumeric characters.

In a preferred embodiment of the present invention the code is transferred to predetermined users, thereby to enable the predetermined users to release the blocked email.

In a preferred embodiment of the present invention the digital code is sent to the authorized person in a manner in which it cannot be seen by the authorized person.

In a preferred embodiment of the present invention the notification contains instructions with which the authorized person can release the blocked message.

In a preferred embodiment of the present invention the notification contains a copy of the blocked message.

In a preferred embodiment of the present invention an initiator of the blocked message receives a notification that does not contain the digital code.

In a preferred embodiment of the present invention the message is any of a group comprising: a client server communication, an email message, an email attachment, an SMS message, a instant messaging communication, a peer to peer communication, fax message and a file being transferred by a file transfer protocol.

The present invention successfully addresses the shortcomings of the presently known configurations by providing a method and system for allow for an efficient handling of false positive indications of unauthorized dissemination of information in a digital traffic filtering system.

### BRIEF DESCRIPTION OF THE DRAWINGS

For a better understanding of the invention and to show how the same may be carried into effect, reference will now be made, purely by way of example, to the accompanying drawings, in which:

FIG. 1 illustrates a system for handling false positive indications of unauthorized dissemination of information, constructed and operative according to a preferred embodiment of the present invention;

FIG. 2 illustrates a system, substantially similar to the one described in FIG. 1, which further comprises an audit database, and

FIG. 3 illustrates a system, substantially similar to the one described in FIG. 2, in which another notification is sent to the sender of the mail.

### DETAILED DESCRIPTION OF PREFERRED EMBODIMENTS

The presently preferred embodiments describe a method and system for an efficient handling of false positive indications of unauthorized dissemination of information in a digital traffic filtering system.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

According to a preferred embodiment of the present invention, in a system which blocks emails according to their content and a distribution policy, the system notifies an authorized person or entity about the blocking, and the notification contains instructions and/or means by which the authorized person or entity can release the email.

In a preferred embodiment of the present invention, the notifications contain visible or invisible code, hereinafter referred to as “force code”, that that is used in order to identify the “blocked” or quarantined message and allows the release of the mail when that code is sent to the server by an authorized person, e.g. using the “reply” or “forward” commands in the mail application.

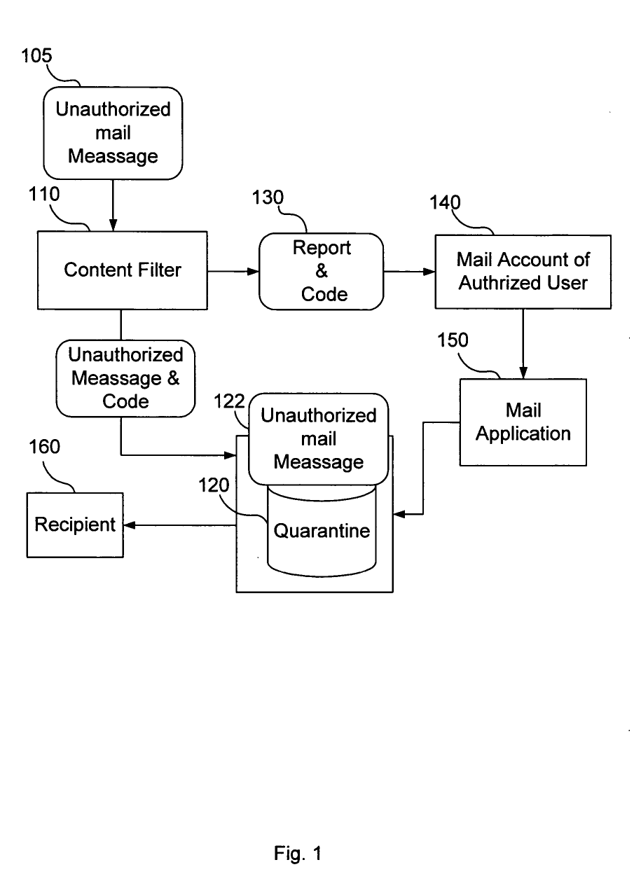

Reference is now made to FIG. 1, which illustrates a system for efficient handling of false positive indications of unauthorized dissemination of information in a digital traffic filtering system, constructive and operative according to a preferred embodiment of the present invention. An unauthorized mail message 105 is sent and passes content filter 110. When unauthorized mail-message 105 is detected as being unauthorized by the content filter 110, the message is “blocked’ and sent to a special storage 120 (“quarantine”) within server 122, together with an identification code (“force code”). At this point a report, together with the “force code” 130 is sent to the mail account of a person (or an entity) 140 that is authorized to “release” the message from quarantine. In the case in which the authorized person or entity 140 decides to release the quarantined message, the authorized person 140 uses the mail application 150 to send the force code to server 122, preferably using a standard command in the mail application, such as “reply” or “forward”. The server then preferably verifies that the authorized person 140 is indeed authorized to release the message. The message is then recognized by the server according to the force code, released from quarantine 120 and is sent to intended recipient 160.

In a preferred embodiment of the present invention, the server authenticate the identity of the sender of the release code based on at least one of the following methods:
The sender email address inside the organization
The sender Media Access Control (MAC) address
Standard Public Key Infrastructure (PKI) authentication scheme

In a preferred embodiment of the present invention, the code is sent in a manner in which it cannot be seen by the authorized person, e.g., by encoding the force code using the “Tab” and “Space” characters within the message body. In a preferred embodiment of the present invention, the force code is first encoded using an Error-Correction Code, and thereafter embedded in the message using non-visible characters.

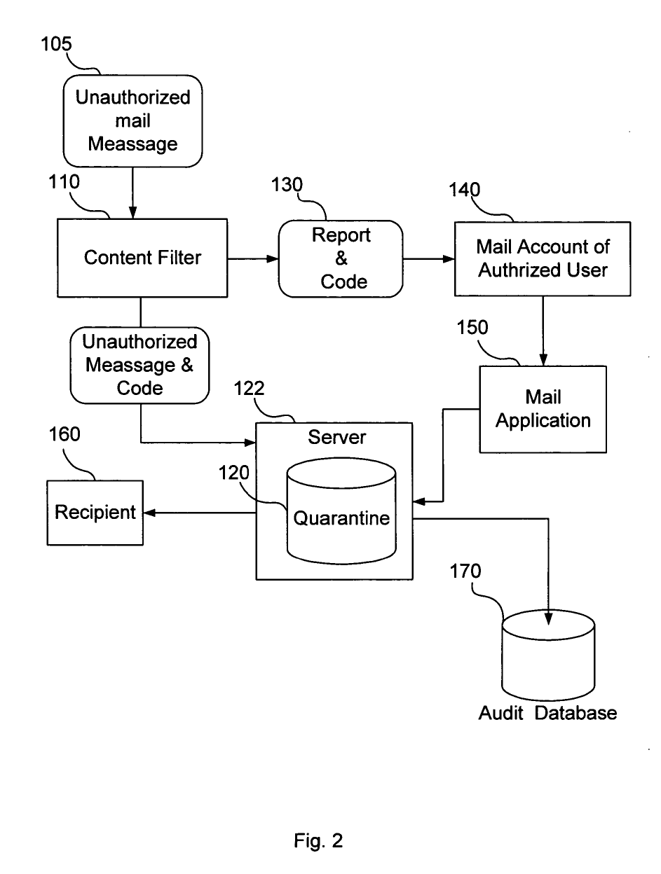

Reference is now made to FIG. 2, which illustrates a system for efficient handling of false positive indications of unauthorized dissemination of information in a digital traffic filtering system, substantially similar to the one described in FIG. 1, but which further comprises an audit database 170, in which the details of any event in which a message was released, together with the relevant parameters, are stored.

In a preferred embodiment of the present invention, the above-referred to authorized person or entity who is allowed to released the blocked mail may be any of certain selected users, such as:
the owner of the information item;
the system administrator;
the sender of the mail and,
the organization security officer.

In a preferred embodiment of the present invention, the force code appears immediately after a unique string of characters and/or numbers, thereby facilitate its recognition by the server. The server uses the force code in order to identify the “blocked” or quarantined message

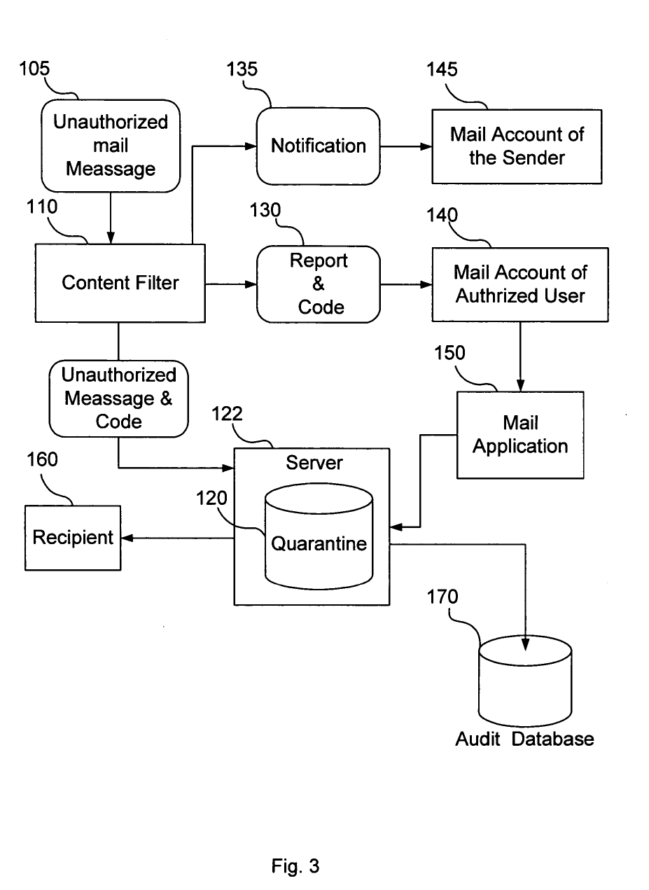

Reference is now made to FIG. 3, which illustrates a system, substantially similar to the one described in FIG. 2, in which a notification 135 is sent to the sender of the mail 145 to indicate to him that the e-mail has been placed in quarantine. The notification sent to the sender does not however contain the force code. At the same time the “force code” 130 is transferred to an authorized user 140 as before, who can release the original email from quarantine 122.

In a preferred embodiment of the present invention, the entire process is done using a single mail client.

The present invention successfully addresses the shortcomings of the presently known configurations by providing a method and system for allow for an efficient handling of false positive indications of unauthorized dissemination of information in a digital traffic filtering system.

It is appreciated that one or more steps of any of the methods described herein may be implemented in a different order than that shown, while not departing from the spirit and scope of the invention.

While the methods and apparatus disclosed herein may or may not have been described with reference to specific hardware or software, the methods and apparatus have been described in a manner sufficient to enable persons of ordinary skill in the art to readily adapt commercially available hardware and software as may be needed to reduce any of the embodiments of the present invention to practice without undue experimentation and using conventional techniques.

A number of features have been shown in various combinations in the above embodiments. The skilled person will appreciate that the above combinations are not exhaustive, and all reasonable combinations of the above features are hereby included in the present disclosure.

While the present invention has been described with reference to a few specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A method for efficient handling of a blocked message in a digital traffic filtering system, the method comprising:
a. sending a notification to an authorized person about said blocking, and
b. including in said notification an override feature by which said authorized person can override said blocking.

2. A method according to claim 1, wherein said override feature within said notification comprises a digital code, the method further comprising sending said code to a message releasing component responsible for releasing said blocked message, in order to allow releasing of said blocked message at said message releasing component.

3. A method according to claim 2, comprising sending said digital code to said message releasing component using either one of a mail reply command and a mail forward command.

4. A method according to claim 2, wherein said digital code is used by said message releasing component in order to identify said blocked message.

5. A method according to claim 2, wherein said digital code comprises a pseudo-random series of alphanumeric characters.

6. A method according to claim 2, comprising transferring said code to predetermined users, thereby to enable said predetermined users to release the blocked email.

7. A method according to claim 2, wherein said digital code is sent to said authorized person in a manner in which it cannot be seen by said authorized person.

8. A method according to claim 1, wherein said authorized person comprises at least one of:
the sender of the mail;
the owner of an information item within said blocked mail;
the system administrator and,
the organization security officer.

9. A method according to claim 1, wherein said notification contains instructions with which said authorized person can release said blocked message.

10. A method according to claim 1, wherein said notification contains a copy of the blocked message.

11. A method according to claim 2, wherein an initiator of said blocked message receives a notification that does not contain said digital code.

12. A method according to claim 1, wherein said message is any of a group comprising: a client server communication, an email message, an email attachment, an SMS message, a instant messaging communication, a peer to peer communication, fax message and a file being transferred by a file transfer protocol.

13. A method according to claim 2, further comprising authenticating the identity of said sender of said digital code.

14. A method according to claim 13, wherein said authenticating of said identity of said sender of said digital code is based on at least one of the following:
said sender email address inside the organization
said sender Media Access Control (MAC) address
a standard Public Key Infrastructure (PKI) authentication scheme

15. A method according to claim 2, wherein said message releasing component is a client program within a server.

16. An apparatus for efficient handling of a blocked message in a digital traffic filtering system, the apparatus comprising:
a. a notification sending component for sending a notification to an authorized person about said blocking, said notification including an override feature by which said authorized person can instruct overriding of said blocking
b. a message releasing component for holding said blocked message and for conditionally releasing said blocked message upon receiving said override instructions from said authorized person.

17. An apparatus according to claim 16, wherein said override feature within said notification comprises a digital code, and wherein said apparatus is configured to send said code to said message releasing component for release of said message.

18. An apparatus according to claim 16, configured to send said digital code to said message releasing component using at least one of a mail reply command and a mail forward command.

19. An apparatus according to claim 17, wherein said message releasing component is configured to use said digital code in order to identify said blocked message.

20. An apparatus according to claim 17, wherein said digital code comprises a pseudo-random series of alphanumeric characters.

21. An apparatus according to claim 17, wherein said code is transferred to at least one predetermined user, thereby to enable said predetermined user to release the blocked email.

22. An apparatus according to claim 17, wherein said digital code is sent to said authorized person in a manner in which it cannot be seen by said authorized person.

23. An apparatus according to claim 21, wherein said authorized person comprises at least one of:
An authorized recipient of said blocked mail;
the sender of the mail;
the owner of an information item within said blocked mail;
the system administrator and,
the organization security officer.

24. An apparatus according to claim 17, wherein said notification contains instructions with which said authorized person can release said blocked message.

25. An apparatus according to claim 17, wherein said notification contains a copy of the blocked message.

26. An apparatus according to claim 17, wherein an initiator of said blocked message receives a notification that does not contain said digital code.

27. An apparatus according to claim 16, wherein said message is any of a group comprising: a client server communication, an email message, an email attachment, an SMS message, a instant messaging communication, a peer to peer communication, fax message and a file being transferred by a file transfer protocol.
